(19) United States
(12) Patent Application Publication
(10) Pub. No.: US 2023/0134626 A1
(43) Pub. Date: May 4, 2023

(54) MACHINING METHOD FOR WORKPIECE

(71) Applicant: FANUC CORPORATION, Minamitsur-gun (JP)

(72) Inventor: Chikara TANGO, Minamitsur-gun, Yamanashi-ken (JP)

(21) Appl. No.: 17/918,376

(22) PCT Filed: Apr. 12, 2021
(86) PCT No.: PCT/JP2021/015163

§ 371 Date: Oct. 12, 2022

(30) Foreign Application Priority Data
Apr. 16, 2020 (JP) 2020-073480

(51) Int. Cl. B23B 3/16; B23B 11/00; B23B 31/20

(52) U.S. Cl. CPC B23B 3/162; B23B 11/00; B23B 31/20

(57) ABSTRACT

Provided is a machining method for a workpiece that is rotated in a machine tool having a main spindle, in which modification of the machine tool is not necessary when machining the workpiece. The machining method for the workpiece includes: a first mounting step in which a workpiece holder that is holding the workpiece is mounted onto the main spindle of the machine tool; and a first machining step in which the main spindle is rotated and the workpiece is machined by a first tool installed on a table of the machine tool.

### TECHNICAL FIELD

The present invention relates to a method for machining a workpiece (machining method for workpiece).

### BACKGROUND ART

Conventionally, there is a machine tool capable of performing both a cutting process by rotating a cutting tool in which the tool is attached to a spindle and the tool is rotated to machine a workpiece and a cutting process by rotating a workpiece in which a lathe machining tool is attached to the spindle and the workpiece is rotated to machine the workpiece (for example, JP 2013-202713 A).

### SUMMARY OF THE INVENTION

In the above-described technique, since the workpiece is machined by the lathe machining tool attached to the spindle, there is a problem that it is necessary to modify the machine tool.

The present invention has been made to solve the above problems, and an object of the present invention is to provide a workpiece machining method that does not require modification of a machine tool when machining a rotating workpiece in the machine tool having a spindle.

According to an aspect of the present invention, there is provided a method for machining a workpiece, the method including: a first attachment step of attaching a workpiece holder holding a workpiece to a spindle of a machine tool; and a first machining step of machining the workpiece with a tool installed on a table of the machine tool, while rotating the spindle.

According to the present invention, when machining a rotated workpiece in a machine tool having a spindle, it is not necessary to modify the machine tool.

### BRIEF DESCRIPTION OF DRAWINGS

FIG. 1 is a schematic view of a cutting machine;

FIG. 2 is a schematic view of a workpiece and a workpiece holder that holds the workpiece;

FIG. 3 is a schematic view showing how a first machining of the workpiece is performed;

FIG. 4 is a schematic view showing how the workpiece holder is attached to a spindle and detached from the spindle;

FIG. 5 is a schematic view showing how a second machining of the workpiece is performed;

FIG. 6 is a flowchart showing a flow of a machining process of the workpiece;

FIG. 7 is a schematic view showing how a workpiece holder is loaded into a turret and how the workpiece holder is removed from the turret;

FIG. 8 is a flowchart showing a flow of a machining process of the workpiece;

FIG. 9 is a flowchart showing a flow of a machining process of the workpiece;

FIG. 10 is a schematic view showing how the first machining of the workpiece is performed; and

FIG. 11 is a schematic view showing how the second machining of the workpiece is performed.

### DESCRIPTION OF THE INVENTION

### First Embodiment

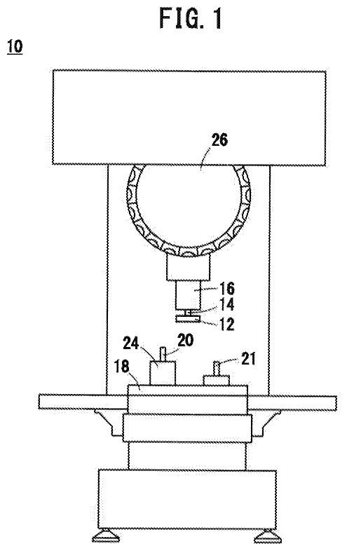

FIG. 1 is a schematic view of a cutting machine 10, The cutting machine 10 performs a first machining and a second machining. The first machining refers to machining that is performed with a workpiece 12 being attached to a spindle 16 side of the cutting machine 10. The second machining refers to machining that is performed with the workpiece 12 being attached to a table 18 side of the cutting machine 10. The cutting machine 10 corresponds to a machine tool of the present invention.

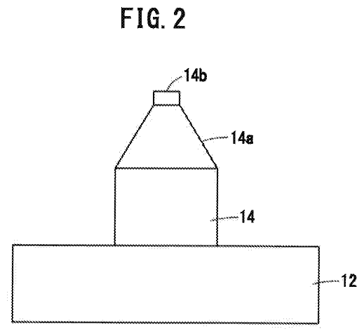

FIG. 2 is a schematic view of the workpiece 12 and a workpiece holder 14 that holds the workpiece 12. The workpiece holder 14 holding the workpiece 12 is mounted on the spindle 16 of the cutting machine 10. As shown in FIG. 2, the workpiece holder 14 has a tapered surface 14a and a pull bolt 14b, similar to those of a collet holder.

A first tool 20 is attached to a collet chuck 24 installed on a table 18 of the cutting machine 10. The collet chuck 24 is formed with a tapered hole having the same shape as the tapered hole of the spindle 16. The collet chuck 24 can rotate the attached first tool 20 or the like by a motor (not shown), but can also fix the first tool 20 or the like so as not to rotate. The first tool 20 is, for example, a cutting tool, a drill, or the like, and is a roughing tool. The first tool 20 is held by a collet holder (not shown). The collet chuck 24 corresponds to a jig of the present invention.

A second tool 21 is installed on the table 18 of the cutting machine 10. Unlike the first tool 20, the second tool 21 is fixed directly to the table 18. The second tool 21 is, for example, a cutting tool, a drill, or the like, and is a finishing tool.

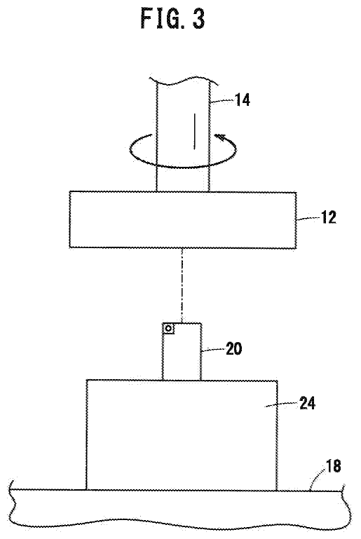

FIG. 3 is a schematic view showing how the first machining of the workpiece 12 is performed. Rough machining or roughing is performed by the first tool 20 installed on the table 18 by rotating the workpiece 12. At this time, the collet chuck 24 non-rotatably fixes the first tool 20. Thereafter, while the workpiece 12 is being rotated, finish machining or finishing is performed by the second tool 21 installed on the table 18. After the roughing, finishing is performed by the second tool 21 installed on the table 18 while the workpiece 12 is being rotated. In the first machining, for example, lathing, boring, threading, drilling, or the like is performed.

The second tool 21 of the finishing tool may be attached to the collet chuck 24, and the first tool 20 of the roughing tool may be directly fixed to the table 18.

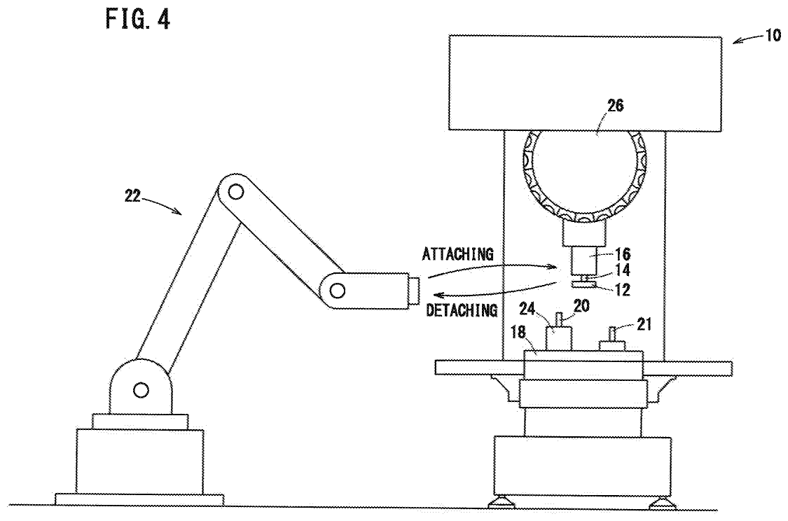

FIG. 4 is a schematic view showing how the workpiece holder 14 is attached to the spindle 16 and how the workpiece holder 14 is detached from the spindle 16. As shown in FIG. 4, the workpiece holder 14 is attached to the spindle 16 and detached from the spindle 16 by a robot 22 provided outside the cutting machine 10. Attachment of the workpiece holder 14 to the spindle 16 and detachment of the workpiece holder 14 from the spindle 16 may be performed by an operator.

Installation of the collet chuck 24 on the table 18 and removal of the collet chuck 24 from the table 18 may be performed by the robot 22 or may be performed by an operator. Attachment of the first tool 20 to the collet chuck 24 and detachment of the first tool 20 from the collet chuck 24 may be performed by the robot 22 or may be performed by an operator. Installation of the second tool 21 on the table 18 and removal of the second tool 21 from the table 18 may also be performed by the robot 22 or may be performed by an operator. The robot 22 corresponds to a changing apparatus of the present invention.

The robot 22 according to the present embodiment is an articulated robot, but is not limited to such an articulated robot, and may be a SCARA robot, etc. Instead of the robot 22, a dedicated device for attaching the workpiece holder 14 or the like to the spindle 16 and detaching the workpiece holder 14 or the like from the spindle 16 may be used.

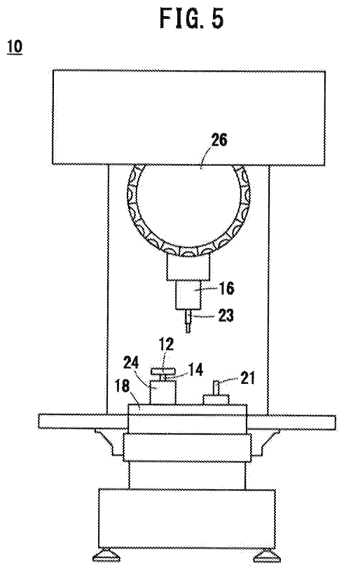

FIG. 5 is a schematic view showing how the second machining of the workpiece 12 is performed. In the second machining, a third tool 23 is attached to the spindle 16 of the cutting machine 10. The third tool 23 is, for example, a milling cutter, an end mill, or the like. The third tool 23 is held by a collet holder (not shown).

The workpiece holder 14 holding the workpiece 12 is attached to the collet chuck 24 installed on the table 18 of the cutting machine 10.

In FIG. 5, the second tool 21 is installed on the table 18 of the cutting machine 10, but the second tool 21 may be removed.

In the second machining, the third tool 23 is rotated to machine the workpiece 12 placed on the table 18. At this time, the collet chuck 24 non-rotatably fixes the workpiece holder 14. In the second machining, for example, milling, end milling, or the like is performed.

In the second machining, a fourth tool (not shown) may be installed on the table 18, and the workpiece 12 may be machined by the fourth tool with the workpiece 12 being rotated. In this case, in the second machining, for example, lathing, boring, threading, drilling, or the like is performed.

The attachment of the third tool 23 to the spindle 16 and the detachment of the third tool 23 from the spindle 16 may be performed by the robot 22 provided outside the cutting machine 10 or may be performed by an operator. The attachment of the workpiece holder 14 to the collet chuck 24 and the detachment of the workpiece holder 14 from the collet chuck 24 may be performed by the robot 22 or may be performed by an operator.

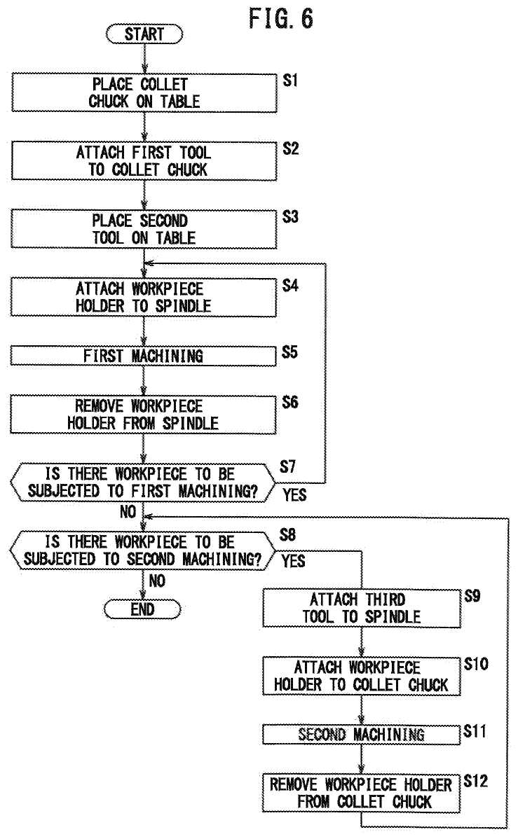

FIG. 6 is a flowchart showing a flow of a machining process of the workpiece 12. The flow of the machining process shown in this flowchart is an example, and the machining process does not necessarily have to be performed in this flow.

In step S1, the robot 22 places the collet chuck 24 on the table 18, and the process proceeds to step S2.

In step S2, the robot 22 attaches the first tool 20 to the collet chuck 24, and the process proceeds to step S3.

In step S3, the robot 22 places the second tool 21 on the table 18, and the process proceeds to step S4.

In step S4, the robot 22 attaches the workpiece holder 14 to the spindle 16, and the process proceeds to step S5. The workpiece 12 is held by the workpiece holder 14.

In step S5, the cutting machine 10 performs the first machining, and the process proceeds to step S6.

In step S6, the robot 22 removes the workpiece holder 14 from the spindle 16, and the process proceeds to step S7.

In step S7, when there is another workpiece 12 to be subjected to the first machining, the process returns to step S4, and when there is no more workpiece 12 to be subjected to the first machining, the process proceeds to step S8.

In step S8, when there is a workpiece 12 to be subjected to the second machining, the process proceeds to step S9, and when there is no workpiece 12 to be subjected to the second machining, the machining process is ended.

In step S9, the robot 22 attaches the third tool 23 to the spindle 16, and the process proceeds to step S10.

In step S10, the robot 22 attaches the workpiece holder 14 to the collet chuck 24, and the process proceeds to step S11.

In step S11, the cutting machine 10 performs the second machining, and the process proceeds to step S12.

In step S12, the robot 22 removes the workpiece holder 14 from the collet chuck 24, and returns to step S8.

### Operational Effect

In general, in the cutting machine 10, a tool is attached on the spindle 16 and a cutting process is performed on the workpiece 12 while the tool is being rotated. When machining is performed by pressing the tool against the rotating workpiece 12 as in lathe machining or the like by the cutting machine 10, it is necessary to modify the cutting machine 10 in order to non-rotatably fix the tool attached to the spindle 16, and there is a problem that the cost increases.

In order to address the above problem, in the present embodiment, the workpiece holder 14 holding the workpiece 12 is attached to the spindle 16 of the cutting machine 10, the spindle 16 is rotated, and the workpiece 12 is machined by the first tool 20 or the second tool 21 attached to the table 18 side. Thus, when machining the rotated workpiece 12, it is not necessary to modify the cutting machine 10, and the cost can be suppressed.

In the present embodiment, after completion of the first machining, the workpiece holder 14 is removed from the spindle 16 by the robot 22 installed outside the cutting machine 10. Thus, detaching of the workpiece holder 14 from the spindle 16 is automatically performed.

In the present embodiment, after the first machining is completed, the workpiece holder 14 is detached from the spindle 16, and then the workpiece holder 14 is attached to the collet chuck 24 installed on the table 18, and the workpiece 12 is machined by the third tool 23 attached to the spindle 16. As a result, it is possible to increase the types of machining that can be performed by one cutting machine 10.

In the present embodiment, the workpiece holder 14 is attached to the spindle 16 by the robot 22 installed outside the cutting machine 10. Thus, attaching of the workpiece holder 14 to the spindle 16 is automatically performed.

In the present embodiment, the first tool 20 is attached to the collet chuck 24 installed on the table 18. In order for the collet chuck 24 to non-rotatably fix the first tool 20, it is necessary to modify the collet chuck 24. However, the cost of modifying the collet chuck 24 is lower than the cost of modifying the cutting machine 10 to non-rotatably fix the first tool 20 attached to the spindle 16 of the cutting machine 10.

Further, the common collet chuck 24 can be used in the first machining and the second machining. Therefore, when changing from the first machining to the second machining, the time for installing the collet chuck 24 can be saved. Further, when changing from the first machining to the second machining, the setup of the workpiece 12 is completed just by attaching the workpiece holder 14 initially attached to the spindle 16, to the collet chuck 24, so that the setup time can be shortened.

### Second Embodiment

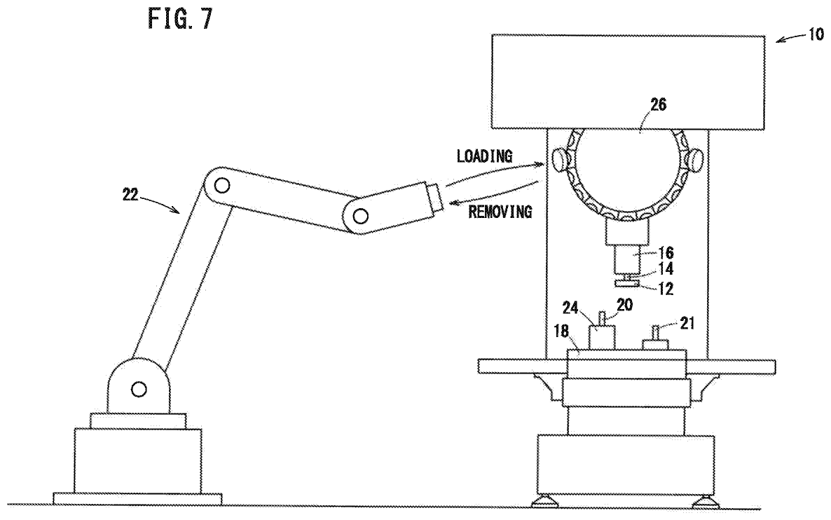

FIG. 7 is a schematic view showing how the workpiece holder 14 is loaded into a turret 26 and how the workpiece holder 14 is removed from the turret 26. The workpiece holder 14 is attached to the spindle 16 and detached from the spindle 16 by the turret 26 of the cutting machine 10. The workpiece holder 14 is loaded into the turret 26 and removed from the turret 26 by a robot 22 provided outside the cutting machine 10. Loading of the workpiece holder 14 into the turret 26 and removing of the workpiece holder 14 from the turret 26 may be performed by an operator. The turret 26 corresponds to a changer of the present invention.

The robot 22 according to the present embodiment is an articulated robot, but is not limited to such an articulated robot, and may be a SCARA robot, etc. Instead of the robot 22, a dedicated device for loading the workpiece holder 14 into the turret 26 and removing the workpiece holder 14 from the turret 26 may be used.

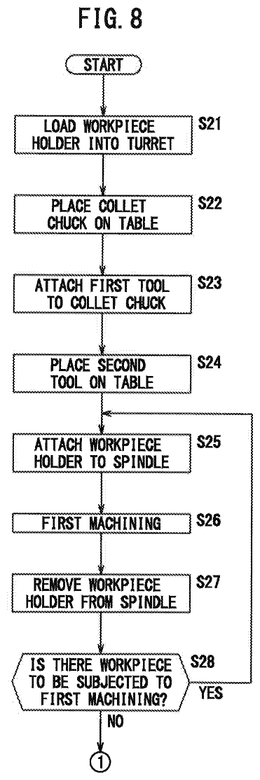

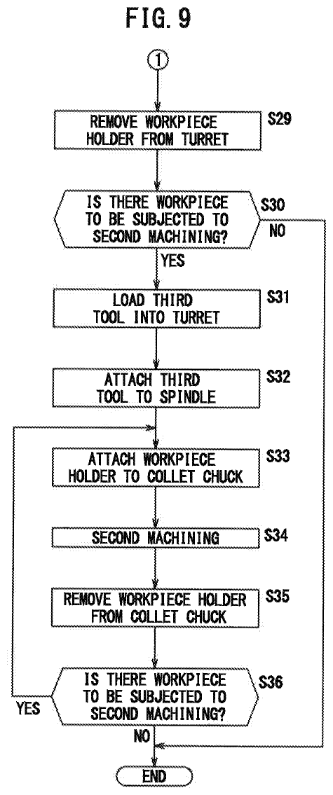

FIGS. 8 and 9 are flowcharts showing the flow of a machining process of the workpiece 12. The flow of the machining process shown in the flowcharts is an example, and the machining process does not necessarily have to be performed in this flow.

In step S21, the robot 22 loads the turret 26 with the workpiece holder 14, and the process proceeds to step S22.

In step S22, the robot 22 places the collet chuck 24 on the table 18, and the process proceeds to step S23.

In step S23, the robot 22 attaches the first tool 20 to the collet chuck 24, and the process proceeds to step S24.

In step S24, the robot 22 places the second tool 21 on the table 18, and the process proceeds to step S25.

In step S25, the turret 26 attaches the workpiece holder 14 to the spindle 16, and the process proceeds to step S26.

In step S26, the cutting machine 10 performs the first machining, and the process proceeds to step S27.

In step S27, the turret 26 removes the workpiece holder 14 from the spindle 16, and the process proceeds to step S28.

In step S28, when there is another workpiece 12 to be subjected to the first machining, the process returns to step S25, and when there is no more workpiece 12 to be subjected to the first machining, the process proceeds to step S29.

In step S29, the robot 22 removes the workpiece holder 14 from the turret 26, and the process proceeds to step S30.

In step S30, when there is a workpiece 12 to be subjected to the second machining, the process proceeds to step S31, and when there is no workpiece 12 to be subjected to the second machining, the machining process is ended.

In step S31, the robot 22 loads the turret 26 with the third tool 23, and the process proceeds to step S32.

In step S32, the turret 26 attaches the third tool 23 to the spindle 16, and the process proceeds to step S33.

In step S33, the robot 22 attaches the workpiece holder 14 to the collet chuck 24, and the process proceeds to step S34.

In step S34, the cutting machine 10 performs the second machining, and the process proceeds to step S35.

In step S35, the robot 22 removes the workpiece holder 14 from the collet chuck 24, and the process proceeds to step S36.

In step S36, when there is another workpiece 12 to be subjected to the second machining, the processing returns to step S33, and when there is no more workpiece 12 to be subjected to the second machining, the machining processing is ended.

### Operational Effect

In the present embodiment, the workpiece holder 14 is loaded into the turret 26 of the cutting machine 10 by the robot 22 provided outside the cutting machine 10, and the turret 26 attaches the workpiece holder 14 to the spindle 16. Thus, attaching of the workpiece holder 14 to the spindle 16 is automatically performed.

### Third Embodiment

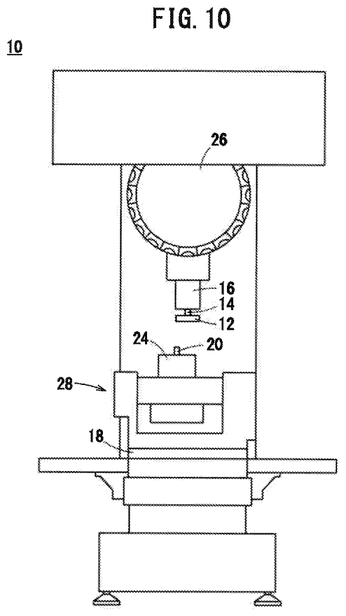

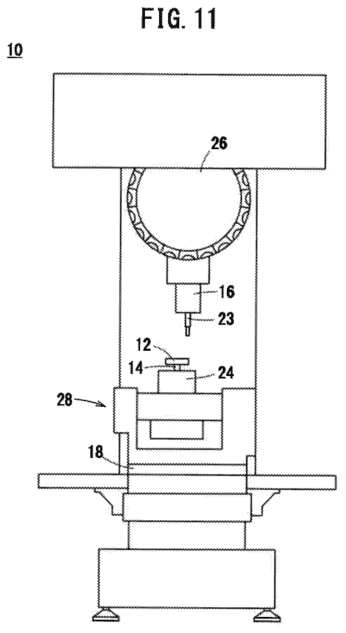

FIG. 10 is a schematic view showing how the first machining of the workpiece 12 is performed. FIG. 11 is a schematic view showing how the second machining of the workpiece 12 is performed.

In the present embodiment, the collet chuck 24 is provided on an additional axis 28 installed on the table 18. The additional axis 28 is capable of rotating the collet chuck 24 about a plurality of different axes.

This embodiment is the same as the first embodiment or the second embodiment except that the collet chuck 24 is provided on the additional axis 28.

### Operational Effect

The collet chuck 24 can be inclined by the additional axis 28, and wide variety of machining can be performed on the workpiece 12.

### Technical Concepts Obtainable from the Embodiments

The following is a description of technical concepts that can be understood from the embodiments described above.

The method for machining the workpiece (12) includes: a first attachment step of attaching a workpiece holder (14) holding a workpiece to a spindle (16) of a machine tool (10); and a first machining step of machining the workpiece with a tool (20) installed on a table (18) of the machine tool, while rotating the spindle.

The above-described workpiece machining method may further include a detachment step of detaching the workpiece holder from the spindle with a changing apparatus (22) installed outside the machine tool, after completion of the first machining step.

The above-described workpiece machining method may further include a second attachment step of attaching the workpiece holder to a jig (24) installed on the table, after completion of the detachment step; and a second machining step of machining the workpiece with the tool attached to the spindle or the tool installed on the table.

In the above-described workpiece machining method, in the first attachment step, the workpiece holder may be attached to the spindle by a changing apparatus provided outside the machine tool.

The above-described workpiece machining method may further include a loading step of loading the workpiece holder into a changer (26) of the machine tool with a changing apparatus provided outside the machine tool, before the first attachment step, and, in the first attachment step, the workpiece holder may be attached to the spindle by the changer.

1. A method for machining a workpiece, the method comprising:
a first attachment step of attaching a workpiece holder holding a workpiece to a spindle of a machine tool; and
a first machining step of machining the workpiece with a tool installed on a table of the machine tool, while rotating the spindle.

2. The method for machining the workpiece according to claim 1, further comprising a detachment step of detaching the workpiece holder from the spindle with a changing apparatus installed outside the machine tool, after completion of the first machining step.

3. The method for machining the workpiece according to claim 2, further comprising:
a second attachment step of attaching the workpiece holder to a jig installed on the table, after completion of the detachment step; and
a second machining step of machining the workpiece with the tool attached to the spindle or the tool installed on the table.

4. The method for machining the workpiece according to claim 1, wherein in the first attachment step, the workpiece holder is attached to the spindle by a changing apparatus provided outside the machine tool.

5. The method for machining the workpiece according to claim 1, further comprising a loading step of loading the workpiece holder into a changer of the machine tool with a changing apparatus provided outside the machine tool, before the first attachment step,
wherein, in the first attachment step, the workpiece holder is attached to the spindle by the changer.
